(19) United States
(12) Patent Application Publication
(10) Pub. No.: US 2026/0312267 A1
(43) Pub. Date: Oct. 8, 2026

(54) METHOD OF MANUFACTURING ELECTRICAL ENERGY STORAGE DEVICE

(71) Applicant: Prime Planet Energy & Solutions, Inc., Tokyo (JP)

(72) Inventors: Takehiro OGURA, Kobe-shi (JP); Taishi KAWASAKI, Kobe-shi (JP); Naofumi NAKATA, Nara-shi (JP)

(21) Appl. No.: 19/639,302

(22) Filed: Apr. 6, 2026

(30) Foreign Application Priority Data
Apr. 8, 2025 (JP) 2025-063411

(51) Int. Cl. H01M 50/636; H01M 10/44

(52) U.S. Cl. CPC H01M 50/636; H01M 10/44; H01M 2220/20

(57) ABSTRACT

In a sealing step of the manufacturing method according to the present disclosure, a third surface is pressed in a first surface direction with a first pressing jig at a first load value, and a pair of second surfaces is pressed from the both sides with second pressing jigs at a second load value. The filling port is then sealed while the second surfaces are deformed toward the inner surfaces of a case body. In a case placement step, the case is placed on a holding member so that a base portion of a holding member is brought into contact with a first surface of the case body. In the sealing step, a region where the first pressing jig faces the third surface is composed of a material having relatively lower hardness than the holding member, and the second load value is larger than the first load value.

### CROSS REFERENCE TO RELATED APPLICATION

This application claims the benefit of priority to Japanese Patent Application No. 2025-063411 filed on Apr. 8, 2025. The entire contents of this application are hereby incorporated herein by reference.

### BACKGROUND OF THE DISCLOSURE

### 1. Field

The present disclosure relates to a method of manufacturing an electrical energy storage device.

### 2. Background

An electrical energy storage device such as a lithium-ion secondary battery comprises, for example, an electrode body, an electrolyte solution, and a case for housing the electrode body and the electrolyte solution. The case comprises a sealing plate and a case body. For example, Japanese Patent Publication No. 2024-64657 discloses a method of manufacturing a secondary battery (an electrical energy storage device) capable of not only preventing the convex expansion of a battery case due to gas generation during charging and discharging, but also preventing an increase in the height of the battery case (a case) when the battery case is pressed.

### SUMMARY

A case body of this type of electrical energy storage device may be provided with a gas release valve for releasing gas within the case to the outside when the pressure in the case exceeds a predetermined value. When a case of this configuration is pressed, a surface of the case body where the gas release valve is provided may undergo deformation, potentially causing the gas release valve to operate inaccurately. Therefore, the above technology has room for further improvement.

The present disclosure is made in light of the above circumstances. An object of the present disclosure is to provide a method of manufacturing an electrical energy storage device capable of not only preventing the expansion of a case due to gas generation during charging and discharging, but also preventing the deterioration in operating accuracy of a gas release valve when the case is pressed.

The technology disclosed herein is a method of manufacturing an electrical energy storage device comprising an electrode body including a positive electrode and a negative electrode, an electrolyte solution, and a case for housing the electrode body and the electrolyte solution. The case comprises a case body having a first surface of a rectangular shape having a pair of long sides and a pair of short sides, a pair of second surfaces each extending from the corresponding long side of the pair of long sides and having a larger area than the first surface, a third surface opposite to the first surface, and one or more openings; and one or more sealing plates for sealing the one or more openings, wherein the first surface is provided with a gas release valve. The manufacturing method according to the present disclosure comprises: a liquid-filling step of filling an electrolyte solution into the case through a filling port provided at the case; a charging step of performing charging; a case placement step of placing the case on a holding member; a sealing step of sealing the filling port while the third surface is pressed in a first surface direction with a first pressing jig at a first load value, and the pair of second surfaces is pressed with second pressing jigs at a second load value to deform the second surfaces in the inner surfaces direction of the case body. The manufacturing method described herein is characterized in that in the case placement step, the holding member includes a base portion, and the case is placed on the holding member so that the base portion is brought into contact with the first surface of the case body; and in the sealing step, a region of the first pressing jig where the first pressing jig faces the third surface of the case body is composed of a material having relatively lower hardness than the holding member, and the second load value is larger than the first load value.

According to this manufacturing method, the deformation of the first surface of the case body can be prevented in the sealing step. Consequently, the sealing step can be performed so that the deterioration in the operating accuracy of the gas release valve can be prevented. Then, the filling port is sealed while the second surfaces of the case body are deformed toward the inner surfaces of the case body. This can prevent the convex expansion of the case due to gas generation during charging and discharging of the electrical energy storage device.

### BRIEF DESCRIPTION OF THE DRAWINGS

FIG. 1 shows a perspective view of an electrical energy storage device according to one embodiment.

FIG. 2 shows a schematic cross-sectional view along the line II-II in FIG. 1.

FIG. 3 shows a schematic cross-sectional view along the line III-III in FIG. 1.

FIG. 4 shows a perspective view of the electrical energy storage device of FIG. 1 inverted upside down.

FIG. 5 shows a schematic view of the configuration of an electrode body;

FIG. 6 shows a flowchart of a method of manufacturing an electrical energy storage device according to one embodiment.

FIG. 7 shows a schematic perspective view of the configuration of a holding member according to one embodiment.

FIG. 8 shows an enlarged schematic view of a case placement step according to one embodiment.

FIG. 9 shows a flowchart of substeps for a sealing step according to one embodiment.

FIG. 10 shows a schematic longitudinal-sectional view during the sealing step (a case pressing step) according to this embodiment. FIG. 10 schematically shows a state before the case body is pressed with pressing jigs. The electrical energy storage device shown in FIG. 10 corresponds to the electrical energy storage device shown in FIG. 3.

FIG. 11 shows a schematic longitudinal-sectional view during the sealing step (the case pressing step) according to this embodiment. FIG. 11 schematically shows a state during the case body is pressed with the pressing jigs. The electrical energy storage device shown in FIG. 11 corresponds to the electrical energy storage device shown in FIG. 3.

FIG. 12 shows a schematic longitudinal-sectional view during the sealing step (the case pressing step) according to this embodiment. FIG. 12 schematically shows a state during the case body is pressed with the pressing jigs. The electrical energy storage device shown in FIG. 12 corresponds to the electrical energy storage device shown in FIG. 2.

FIG. 13 shows a perspective view of a first pressing jig according to this embodiment inverted upside down.

### DETAILED DESCRIPTION OF THE PREFERRED EMBODIMENTS

Several preferred embodiments of the present disclosure will be described with reference to the accompanying drawings as appropriate. Those matters which are not specifically mentioned in the present specification, but are necessary for implementing the present disclosure (for example, a general configuration and manufacturing process of an electrical energy storage device not characterized by the present disclosure) may be considered as design matters within the level of those skilled in the art based on conventional technologies. The present disclosure can be implemented based on the contents disclosed in the present specification and the common technical knowledge in the art.

It is noted that in the following drawings, the same symbols are assigned to those components and parts performing the same functions, and redundant explanations may be omitted or simplified. The expression “A to B” as used for indicating a range in the present specification shall encompass both the meaning of “A or more and B or less” and the meaning of “above A and below B.”

It is noted that in the following description, the symbols L, R, F, Rr, U, and D in the drawings represent left, right, front, rear, upper, and down, respectively. The symbols X, Y, and Z in the drawings represent the short side direction, the long side direction perpendicular to the short side direction, and the vertical direction (also referred to as the height direction) perpendicular to both the short side direction and the long side direction of the electrical energy storage device 100, respectively. However, these directions are defined for the sake of explanation and shall not in any way limit the installation modes of the electrical energy storage device 100.

The term “electrical energy storage device” as used in the present specification refers to a device in which charging and discharging occur due to the movement of charge carriers between a pair of electrodes (a positive electrode and a negative electrode) through an electrolyte. Examples of the electrical energy storage device include secondary batteries such as lithium-ion secondary batteries, nickel-metal hydride batteries, and nickel-cadmium batteries; capacitors such as lithium-ion capacitors and electric double-layer capacitors. The electrical energy storage device may be, for example, a lithium-ion secondary battery.

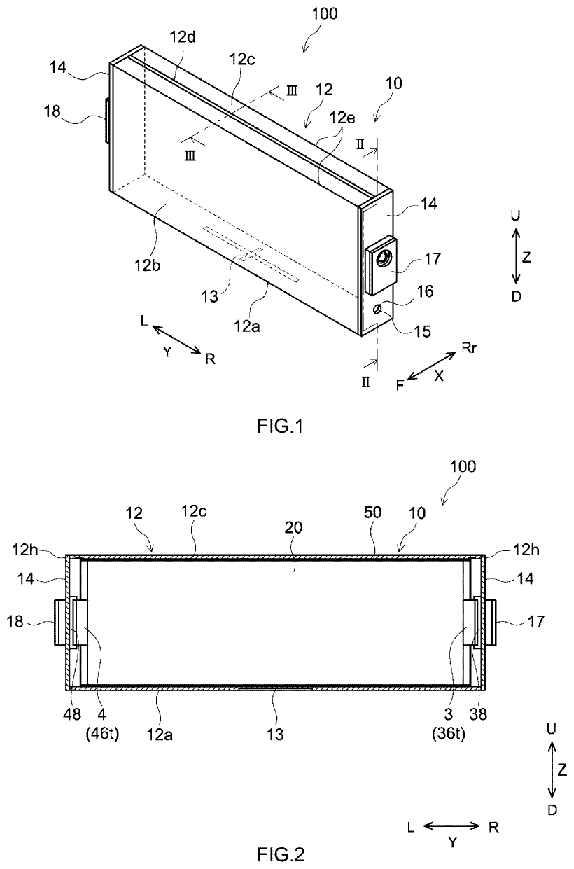

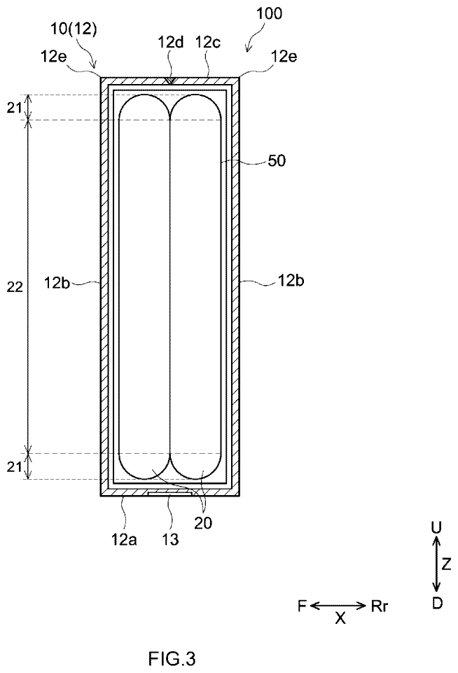

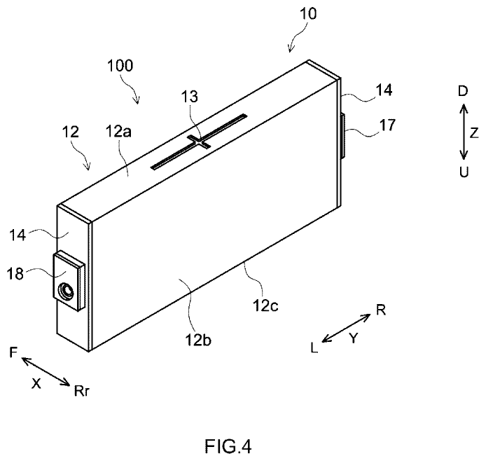

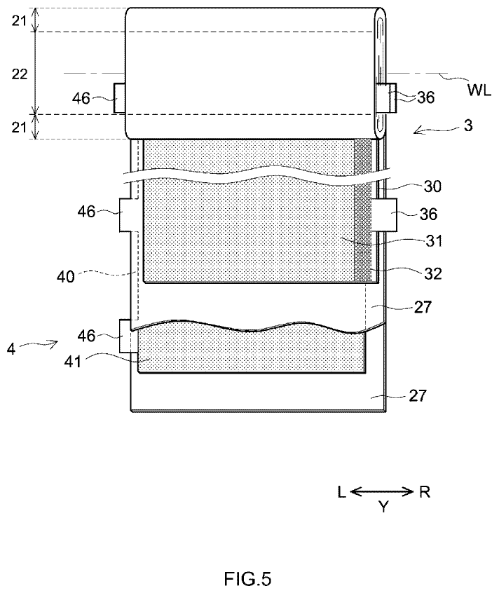

FIG. 1 shows a perspective view of an electrical energy storage device 100 according to one embodiment. FIG. 2 is a schematic cross-sectional view along the line II-II in FIG. 1. FIG. 3 is a schematic cross-sectional view along the line III-III in FIG. 1. FIG. 4 shows a perspective view of the electrical energy storage device 100 of FIG. 1 inverted upside down. Although not shown in the figures, the electrical energy storage device 100 further includes an electrolyte solution in this embodiment. The electrical energy storage device 100 in this embodiment is a lithium-ion secondary battery.

A case 10 is a housing for accommodating an electrode body 20 and the electrolyte solution. As shown in FIG. 1, the case 10 has a flattened and cuboidal (rectangular) outer shape with a bottom. The case 10 comprises a case body 12 having one or more openings 12h, and one or more sealing plates 14 for sealing the one or more openings 12h. As shown in FIG. 2, the case 10 of this embodiment comprises a case body 12 and two sealing plates 14. The case body 12 has a pair of openings 12h (in other words, two openings 12h) each at the corresponding end of the two ends along the long side direction Y. Two sealing plates 14 each close the corresponding opening 12h of the pair of openings 12h in the case body 12.

There is no particular limitation for the material of the case 10 as long as it has a specified strength. Examples of such a material include metal materials primarily composed of aluminum, metal materials primarily composed of iron (such as stainless steel), and other materials.

The case body 12 in this embodiment is a hollow and rectangular tube. As shown in FIG. 1, the case body 12 comprises a first surface 12a, a pair of second surfaces 12b, and a third surface 12c. The first surface 12a is of a substantially rectangular shape having a pair of long sides and a pair of short sides. The pair of second surfaces 12b each extend from the corresponding long side (edge) of the first surface 12a (in this embodiment, upward) and face each other. The third surface 12c connects the upper ends of the pair of second surfaces 12b and is located opposite the first surface 12a. The second surfaces 12b have an area larger than that of the first surface 12a. The second surfaces 12b in this embodiment also have an area larger than that of the third surface 12c. In this embodiment, the areas of the first surface 12a and the third surface 12c are substantially the same.

It is noted that the term “substantially rectangular shape” as used in the present specification encompasses not only a perfect rectangular shape (rectangular form) but also those shapes having rounded corners (R-shaped) connecting the long and short sides of a rectangle, those shapes having notches at the corners, and the like.

The case body 12 can be formed, for example, by bending a single metal plate into a hollow structure and joining (e.g., welding) the edges. Therefore, in this embodiment, the first surface 12a, the pair of second surfaces 12b, and the third surface 12c are each flat plate-Our shaped and have a substantially uniform plate thickness. In this embodiment, a welded joint 12d is provided on the third surface 12c of the case body 12. In the case body 12 according to this embodiment, boundary portions (edges) between the second surfaces 12b and the first surface 12a, and boundary portions (edges) between the second surfaces 12b and the third surface 12c correspond to bent portions.

As shown in FIG. 4, the first surface 12a of the case body 12 comprises a gas release valve 13. The gas release valve 13 is a thin-walled portion configured to break when the pressure inside the case 10 reaches or exceeds a predetermined value, thereby releasing the gas inside the case 10 to the outside. It is noted that the number of the gas release valve 13 is one in this embodiment, but two or more may be used.

As shown in FIG. 4, the gas release valve 13 has a cross-shaped notch configuration in this embodiment. However, there is no particular limitation for the configuration of the gas release valve 13. In other embodiments, the gas release valve 13 may be, for example, a linear notch (a vertical line only or a horizontal line only), or may be a conventionally known elliptical valve (having a notch inside), a circular valve (having a notch inside), or the like. The dimensions (length, depth, and area) of the gas release valve 13 are arbitrary, and can be appropriately determined based on factors, such as, for example, the pressure resistance of the case 10.

The sealing plates 14 are plate-shaped members having substantially rectangular shapes. The areas of the sealing plates 14 are smaller than those of the first surface 12a, the second surfaces 12b, and the third surface 12c. The sealing plates 14 are flat plate-shaped, and have substantially uniform plate thickness. As shown in FIG. 1, one of the sealing plates 14 (in this embodiment, in the R side) is provided with a filling port 15. The filling port 15 is provided for pouring the electrolyte solution into the case 10 after the pair of sealing plates 14 is attached to the case body 12. The filling port 15 is sealed with a sealing member 16 after pouring the electrolyte solution. There is no particular limitation for the sealing member 16, and any publicly known members may be used. Examples of the sealing member 16 include blind rivets. The filling port 15 is preferably provided in the sealing plate(s) 14. However, the configuration is not limited to this. In other embodiments, the filling port 15 may be provided in the case body 12.

The electrolyte solution is contained inside the case 10 along with the electrode body 20. There is no particular limitation for the electrolyte solution, and those for use in common electrical energy storage devices can be used. The electrolyte solution is typically a non-aqueous liquid electrolyte (non-aqueous electrolyte solution) including a non-aqueous solvent and a supporting salt. Non-aqueous solvents include, for example, carbonates such as ethylene carbonate (EC), ethyl methyl carbonate (EMC), and dimethyl carbonate (DMC). The non-aqueous solvent is preferably a mixture of EC, EMC, and DMC each within the range of 1 to 99% relative to the total percent of 100%. The supporting salt is, for example, a fluorine-containing lithium salt. Fluorine-containing lithium salts preferably include lithium hexafluorophosphate (LiPF₆), lithium bis(fluorosulfonyl)imide (F₂LiNO₄S₂), or mixtures thereof. The concentration of the supporting salt is preferably 0.6 to 1.8 mol per liter of a non-aqueous solvent.

A positive electrode terminal 17 and a negative electrode terminal 18 are each fixed to the case 10. The positive electrode terminal 17 and the negative electrode terminal 18 in this embodiment are each fixed to the corresponding surface of the opposite surfaces (specifically, the sealing plates 14) of the case 10. For details, the positive electrode terminal 17 is attached to the sealing plate 14 arranged at one side in the long side direction Y (the right side in FIGS. 1 and 2). The negative electrode terminal 18 is attached to the sealing plate 14 arranged at the other side in the long side direction Y (the left side in FIGS. 1 and 2). However, the positive electrode terminal 17 and the negative electrode terminal 18 may be attached to a single sealing plate 14 (in other words, to one of the pair of sealing plates 14). The positive electrode terminal 17 and the negative electrode terminal 18 are preferably provided at the sealing plates 14. However, the positive electrode terminal 17 and the negative electrode terminal 18 may be provided at the case body 12. Further, in this embodiment, the positive electrode terminal 17 and the negative electrode terminal 18 are provided on a surface(s) different from a surface having the gas release valve 13. However, the positive electrode terminal 17 and the negative electrode terminal 18 may be provided on the same surface as the gas release valve 13.

The positive electrode terminal 17 and the negative electrode terminal 18 are each exposed to a surface outside of the corresponding sealing plate 14. In this embodiment, the positive electrode terminal 17 and the negative electrode terminal 18 are arranged on an axis line extending in the long side direction Y and passing through the center of the sealing plates 14. However, in other embodiments, the axis line may be offset from the center of the sealing plates 14, for example, in the short side direction X. The positive electrode terminal 17 and the negative electrode terminal 18 need not be arranged along the same axis line. For example, one of the positive electrode terminal 17 and the negative electrode terminal 18 may be offset toward one side of the short side direction X, while the other is offset toward the opposite side of the short side direction X.

The positive electrode terminal 17 is preferably made of a metal, and more preferably consists of aluminum or an aluminum alloy. The negative electrode terminal 18 is preferably made of a metal, and more preferably consists of, for example, copper or a copper alloy.

As shown in FIG. 2, the positive electrode terminal 17 is electrically connected inside the case 10 to a positive electrode 3 (a positive electrode tab group 36t) of the electrode body 20 via a positive electrode current collecting member 38. The negative electrode terminal 18 is electrically connected inside the case 10 to a negative electrode 4 (a negative electrode tab group 46t) of the electrode body 20 via a negative electrode current collecting member 48. The positive electrode terminal 17 and the negative electrode terminal 18 are insulated from the case body 12 with an insulating sheet 50.

The electrode body 20 is housed inside the case 10. In this embodiment, a plurality (in this embodiment, two) of electrode bodies 20 are housed in a single case 10. However, there is no particular limitation for the number of electrode bodies 20 housed in a single case 10. In other embodiments, it may be 3 or more, or it may be one.

As shown in FIGS. 2 and 3, the electrode body 20 may be arranged inside the case body 12 in a state where it is covered by the insulating sheet 50 (an electrode body holder). For example, the insulating sheet 50 is folded into a box-shaped structure, and the electrode body 20 is placed inside that insulating sheet 50. This can prevent the electrode body 20 from making direct contact with the case body 12. The insulating sheet 50 is preferably made of a resin.

FIG. 5 shows a schematic view of the configuration of the electrode body 20. As shown in FIG. 5, the electrode body 20 has the positive electrode 3 and the negative electrode 4. The electrode body 20 is preferably flattened. As shown in FIG. 5, the electrode body 20 is a flattened wound electrode body in which a strip-shaped positive electrode 3 and a strip-shaped negative electrode 4 are laminated in an insulating manner via a strip-shaped separator 27, and then wound around a winding axis WL. However, the electrode body 20 may be a laminated electrode body in which a plurality of quadrate (typically rectangular) positive electrodes and a plurality of quadrate (typically rectangular) negative electrodes are laminated in an insulating manner.

As shown in FIG. 3, the electrode body 20 in this embodiment has a pair of curved portions 21 facing the first surface 12a and the third surface 12c of the case body 12, and a flat portion 22 connecting the pair of curved portion 21 and facing the second surface 12b of the case body 12.

As shown in FIG. 5, the positive electrode 3 has a positive electrode current collector 30, a positive electrode active material layer 31 adhered to at least one surface of the positive electrode current collector 30, and a positive electrode protective layer 32. However, the positive electrode protective layer 32 is not essential and may be omitted in other embodiments. The positive electrode current collector 30 is made of an electrically conductive metal such as aluminum, an aluminum alloy, nickel, or stainless steel, and preferably consists of aluminum or an aluminum alloy. The positive electrode active material layer 31 is a layer including a positive electrode active material capable of reversibly occluding and releasing charge carriers. As the positive electrode active material, oxides containing at least one of Ni, Co, and Mn are preferred. Examples of the positive electrode active material include lithium transition metal composite oxides such as lithium cobalt oxide, lithium manganese oxide, lithium nickel oxide, lithium nickel manganese composite oxide, and lithium nickel cobalt composite oxide. The positive electrode active material preferably includes, for example, a lithium nickel composite oxide, i.e., a composite oxide containing Ni and Li, in which the content of Ni in the composite oxide is in the range of 70 to 100 mol % relative to the total moles of constituent elements other than Li and oxygen in the composite oxide. Examples of the positive electrode active material also include those in which some of Ni, Co, and/or Mn are replaced with Al, Ti, Zr, P, B, Si, Nb, C, and/or others; and those in which the surface of a particle are coated with a compound containing Al, Ti, Zr, W, P, B, Si, Nb, C, and/or others. The replacement amount and the addition amount of such substances may be around 0.1 to 7% in total relative to the total amount of the positive electrode active material. The positive electrode protective layer 32 is a layer including an inorganic filler such as alumina.

As shown in FIG. 5, the negative electrode 4 has a negative electrode current collector 40 and a negative electrode active material layer 41 bonded on the negative electrode current collector 40. The negative electrode current collector 40 consists of, for example, an electrically conductive metal such as copper, a copper alloy, nickel, and stainless steel, and preferably consists of copper or a copper alloy. The negative electrode active material layer 41 is a layer including a negative electrode active material capable of reversibly occluding and releasing charge carriers. Negative electrode active materials include, for example, carbon materials such as graphite and carbon; and metals and compounds thereof capable of occluding lithium, such as Si, SiO, SiC, and Sn.

A plurality of positive electrode tabs 36 are provided at one end (the right end in FIG. 5) in the long side direction Y of the positive electrode current collector 30. The plurality of positive electrode tabs 36 each protrude toward one side (the right side in FIG. 5) in the long side direction Y. The plurality of positive electrode tabs 36 protrude in the long side direction Y beyond the separator 27. The plurality of positive electrode tabs 36 in this embodiment are each trapezoidal in shape. However, the shape of the positive electrode tabs 36 is not limited to this. There is also no particular limitation for the size of the plurality of positive electrode tabs 36. The shapes and the sizes of the positive electrode tabs 36 can be appropriately adjusted according to positions of formation and other factors, for example, considering how they are connected to the positive electrode current collecting member 38. The positive electrode tabs 36 preferably consist of a metal foil, and more preferably consist of an aluminum foil or an aluminum alloy foil. In this embodiment, the positive electrode tabs 36 are portions of the positive electrode current collector 30 where the positive electrode active material layer 31 and the positive electrode protective layer 32 are not formed (a so-called current collector exposed portion). However, the positive electrode tabs 36 may be separate members from the positive electrode current collector 30.

A plurality of negative electrode tabs 46 are provided at one end (the left end in FIG. 5) in the long side direction Y of the negative electrode current collector 40. The plurality of negative electrode tabs 46 protrude toward one side (the left side in FIG. 5) in the long side direction Y. The plurality of negative electrode tabs 46 protrude in the long side direction Y beyond the separator 27. The plurality of negative electrode tabs 46 in this embodiment are each trapezoidal in shape. However, the shape of the negative electrode tabs 46 is not limited to this. There is also no particular limitation for the size of the plurality of negative electrode tabs 46. The shapes and the sizes of the negative electrode tabs 46 can be appropriately adjusted according to positions of formation and other factors, for example, considering how they are connected to the negative electrode current collecting member 48. The negative electrode tabs 46 preferably consist of a metal foil, and more preferably consist of a copper foil or a copper alloy foil. In this embodiment, the negative electrode tabs 46 are portions of the negative electrode current collector 40 where the negative electrode active material layer 41 is not formed (a so-called current collector exposed portion). However, the negative electrode tabs 46 may be separate members from the negative electrode current collector 40.

The separator 27 is a member which insulates the positive electrode active material layer 31 of the positive electrode 3 from the negative electrode active material layer 41 of the negative electrode 4. As the separator 27, a porous resin sheet consisting of a polyolefin resin such as, for example, polyethylene (PE) and polypropylene (PP) is preferred. It is noted that a surface of the separator 27 may be provided with a heat-resistance layer (HRL) including an inorganic filler. As the inorganic filler, for example, alumina, boehmite, aluminum hydroxide, titania, and the like are used.

As shown in FIGS. 3 and 5, the plurality of positive electrode tabs 36 are stacked at one end in the long side direction Y (the right end in FIG. 5), forming the positive electrode tab group 36t. On the other hand, the plurality of negative electrode tabs 46 are stacked at one end in the long side direction Y (the left end in FIG. 5), forming the negative electrode tab group 46t. In this embodiment, the electrical energy storage device 100 has a so-called side-tab structure, in which the positive electrode tab group 36t and the negative electrode tab group 46t are located in the right and left sides of the electrode body 20, respectively. The positive electrode tab group 36t is curved while joined to the positive electrode current collecting member 38. The negative electrode tab group 46t is curved while joined to the negative electrode current collecting member 48.

The positive electrode current collecting member 38 forms a conductive path which electrically connects the positive electrode tab group 36t of the electrode body 20 to the positive electrode terminal 17. The positive electrode current collecting member 38 is preferably composed of a metal with excellent electrical conductivity, and composed of, for example, aluminum or an aluminum alloy. The negative electrode current collecting member 48 forms a conductive path which electrically connects the negative electrode tab group 46t of the electrode body 20 to the negative electrode terminal 18. The negative electrode current collecting member 48 is preferably composed of a metal with excellent electrical conductivity, and composed of, for example, copper or a copper alloy.

### Method of Manufacturing Electrical Energy Storage Device 100

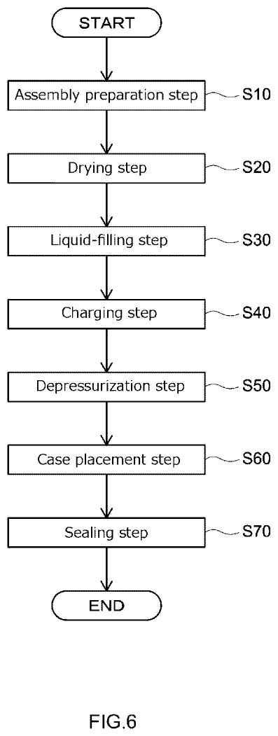

The method of manufacturing an electrical energy storage device 100 disclosed herein is characterized by comprising a liquid-filling step, a charging step, a case placement step, and a sealing step. The method of manufacturing an electrical energy storage device 100 disclosed herein may further comprise another step at any stages in addition to the above steps. FIG. 6 shows a flowchart of a method of manufacturing an electrical energy storage device according to one embodiment. The electrical energy storage device 100 can be manufactured by a manufacturing method comprising the following steps typically in this order: (1) an assembly preparation step S10, (2) a drying step S20, (3) a liquid-filling step S30, (4) a charging step S40, (5) a depressurization step S50, (6) a case placement step S60, and (7) a sealing step S70, as shown in FIG. 6. However, the steps are not particularly limited to these. The method of manufacturing an electrical energy storage device disclosed herein is characterized by the case placement step S60 and the sealing step S70, while the other manufacturing processes may be the same as those used in conventional methods.

### (1) Assembly Preparation Step S10

In the assembly preparation step S10, the electrode body 20 is placed inside the case 10 (the case body 12) to prepare an assembly. It is noted that the term “assembly” as used in the present specification refers to an electrical energy storage device which has been assembled to a point prior to performing the charging step S40 described below.

In the assembly preparation step S10, prepared are, for example, the case 10 (the sealing plates 14 and the case body 12), the electrode body 20, the positive electrode terminal 17, the negative electrode terminal 18, the positive electrode current collecting member 38, the negative electrode current collecting member 48, and the insulating sheet 50. The electrical energy storage device 100 disclosed herein is characterized by the case 10 (the case body 12 and the sealing plates 14), while the configurations other than these may be the same as conventional configurations.

The case body 12 prepared in the assembly preparation step S10 comprises a first surface 12a, a pair of second surfaces 12b, a third surface 12c, and one or more openings 12h. The first surface 12a has a substantially rectangular shape having a pair of long sides and a pair of short sides, and comprises a gas release valve 13. The pair of second surfaces 12b each extend from the corresponding long side of the pair of long sides of the first surface 12a and has an area larger than that of the first surface 12a. The third surface 12c is located opposite to the first surface 12a. The case body 12 prepared in this embodiment is a hollow and rectangular tube, and has an opening 12h at each end in the long side direction Y. The case body 12 is made of a metal, and preferably composed of a metal material composed primarily of aluminum. It is noted that the term “metal material composed primarily of aluminum” as used in the present specification refers to a metal material containing 90 mass % or more of aluminum relative to the total weight. The term encompasses, for example, aluminum, aluminum alloys, and the like.

It is preferred that the first surface 12a, the pair of second surfaces 12b, and the third surface 12c are each flat plate-shaped and have a substantially uniform plate thickness. The plate thickness (metal plate thickness) of the case body 12 is preferably 2.5 mm or less, more preferably 1.5 mm or less, and even more preferably 1.0 mm or less. There is no particular limitation for the lower limit of the plate thickness of the case body 12, but it may be, for example, 0.5 mm or more.

It is noted that the case body 12 may be purchased commercially or produced by using conventionally known methods. The case body 12 can be formed, for example, by bending a single metal plate into a rectangular tube and joining (e.g., welding) the edges. This allows for obtaining a case body 12 in which the first surface 12a, the pair of second surfaces 12b, and the third surface 12c are each flat plate-shaped and have a substantially uniform plate thickness. When forming the case body 12 by using this forming method, the edges are preferably joined at the third surface 12c. In other words, a welded joint 12d is preferably formed at the third surface 12c. The welded joint 12d has relatively lower hardness as compared to the first surface 12a and the second surfaces 12b. Therefore, the formation of the welded joint 12d at the third surface 12c allows for more suitable dissipation of the expansion force to be exerted on the first surface 12a when the case 10 is pressed. However, the configuration is not limited to this, and the case body 12 may be formed by joining a plurality of metal plates.

The sealing plates 14 prepared in the assembly preparation step S10 are preferably made of a metal, and preferably composed of a metal material composed primarily of aluminum. Further, the plate thicknesses of the sealing plates 14 are preferably larger than that of the case body 12. This enables the sealing plates 14 to have a certain degree of strength, thereby preventing the deformation of the case 10 in the sealing plates 14 direction (the long side direction Y) in the sealing step S70 described below. The plate thicknesses of the sealing plates 14 are preferably 1.5 mm or more, more preferably 1.8 mm or more, and even more preferably 2.0 mm or more. According to the sealing plates 14 having the above configuration, the deformation of the sealing plates 14 can be prevented in the sealing step S70 described below while the third surface 12c of the case body 12 is suitably allowed to be more readily deformed. Therefore, the deformation of the gas release valve 13 in the case body 12 can be prevented more effectively. There is no particular limitation for the upper limit of the plate thicknesses of the sealing plates 14, but they may be, for example, 10.0 mm or less. The positive electrode terminal 17 and the negative electrode terminal 18 are preferably attached to the sealing plates 14. In this embodiment, a sealing plate 14 having the positive electrode terminal 17 attached and a sealing plate 14 having the negative electrode terminal 18 attached are each prepared.

The case body 12 and the sealing plates 14 are preferably made of the same type of material, and in particular preferably composed of a metal material composed primarily of aluminum. However, the materials of the case body 12 and the sealing plates 14 may be different from each other.

The electrode body 20 may be purchased commercially or produced by using conventionally known methods. In this embodiment, an electrode body 20 placed within an insulating sheet 50 folded into a box shape is prepared. In the assembly preparation step S10, the negative electrode current collecting member 48 is attached to the negative electrode tab group 46t. Then, the negative electrode current collecting member 48 and the negative electrode terminal 18 attached to one of the sealing plates 14 are joined by using a conventionally known method (e.g., ultrasonic joining, resistance welding, laser welding, and the like). Thereby, the electrode body 20 is integrated with one of the sealing plates 14. Then, the electrode body 20 is accommodated (inserted into) in the case body 12 from the side of the positive electrode tab group 36t. Subsequently, the positive electrode current collecting member 38 is attached to the positive electrode tab group 36t of the electrode body 20. Then, the positive electrode current collecting member 38 and the positive electrode terminal 17 attached to the other of the sealing plates 14 are joined by using a conventionally known method (e.g., ultrasonic joining, resistance welding, laser welding, and the like). Then the case body 12 and the sealing plates 14 can be joined together to produce an assembly. Such joining can be performed by welding such as laser welding.

In the assembly preparation step S10, the electrode body 20 is preferably positioned inside the case body 12 such that the thickness (stacking) direction of the electrode body 20 is substantially perpendicular to the second surfaces 12b (i.e., oriented orthogonally to the second surfaces 12b). In other words, the electrode body 20 is preferably positioned within the case 10 in an orientation where the thickness direction of the case 10 coincides with the thickness direction of the electrode body 20 (in the short side direction X). When the electrode body 20 is a wound electrode body, the electrode body 20 is preferably positioned inside the case body 12 such that the winding axis WL of the electrode body 20 is parallel to the first surface 12a of the case body 12. In other words, the electrode body 20 is preferably positioned inside the case body 12 such that the pair of curved portions 21 of the electrode body 20 each face the first surface 12a or the third surface 12c of the case body 12. By this, a gap may tend to be formed between the second surfaces 12b and the curved portions 21 of the electrode body 20, allowing the case 10 (the case body 12) to be ready deformed into an intended shape.

### (2) Drying Step S20

In the drying step S20, the assembly is dried to remove moisture contained in the assembly (e.g., inside the electrode body 20). This drying process can be performed by using a known method. For example, the drying step S20 can be performed by conveying the assembly (the case 10 having the electrode body 20 therein) into a drying furnace (not shown) for heating.

The drying temperature and the drying time in the drying step S20 can be adjusted appropriately depending on the content of moisture in the electrode body 20 and other factors. There is no particular limitation for the drying temperature as long as it is within a range where moisture can be removed. However, drying is desirably performed at a temperature which does not damage the separator 27 of the electrode body 20. Further, the drying step S20 may be performed under the atmospheric pressure or under a reduced pressure. The drying step S20 is preferably performed under a reduced pressure. This enables a reduced drying time in the drying step S20. It is noted that the drying step S20 is not an essential step for the technology disclosed herein. In some preferred embodiments, the drying step S20 may be omitted.

### (3) Liquid-filling Step S30

In the liquid-filling step S30, the case 10 having the electrode body 20 accommondated therein is filled with an electrolyte solution through a filling port 15 provided in the sealing plate(s) 14. The liquid-filling step S30 may be performed under the atmospheric pressure or under a reduced pressure. Although not limited to this, the liquid-filling step S30 is preferably performed under a reduced pressure. This can improve the ability of the electrolyte solution to permeate into the electrode body 20, enabling the liquid-filling step S30 to be completed in a shorter time. In the liquid-filling process, the electrolyte solution is introduced in a volume sufficient to spread throughout the entire electrode body 20. In the liquid-filling step S30, a publicly known electrolyte solution-filling device may be used appropriately. It is noted that examples of a pressurizing gas which can be used to pump the electrolyte solution include inert gases such as nitrogen (N₂), dry air, and the like as used in conventional ways. After completion of the liquid-filling step S30, pressurization and depressurization inside the case 10 are preferably performed in an appropriate manner.

### (4) Charging Step S40

In the charging step S40, the assembly is charged. By performing the charging step S40, a high-quality coating can be formed on a surface of the negative electrode active material layer 41. The gas generated in the charging step S40 is released to the outside of the case 10. There is no particular limitation for the charging conditions in this step, but they may be similar to the conditions used in a conventional method of manufacturing an electrical energy storage device. In the charging step S40, the filling port 15 may be temporarily sealed. However, in the charging step S40, the filling port 15 is not completely sealed.

### (5) Depressurization Step S50

In the depressurization step S50, the inside of the case 10 is depressurized to further release any gas present inside the case 10 (e.g., air or gas generated in the charging step S40) to the outside of the case 10. The depressurization step S50 may be similar to a depressurization step in a conventional method of manufacturing an electrical energy storage devices, and does not particularly characterize the technology disclosed herein. Therefore, further detailed description will be omitted. It is noted that the depressurization step S50 is not an essential step for the technology disclosed herein. In some preferred embodiments, the depressurization step S50 may be omitted.

### (6) Case Placement Step S60

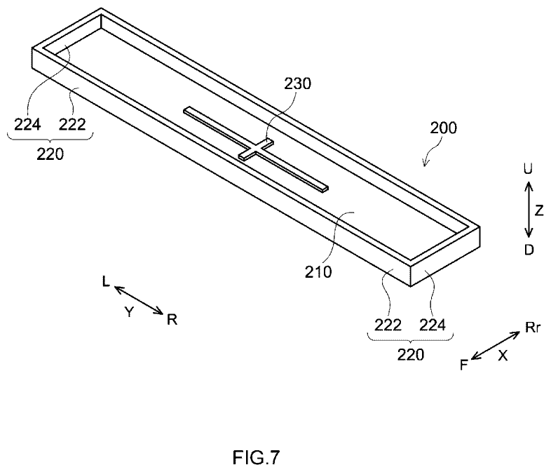

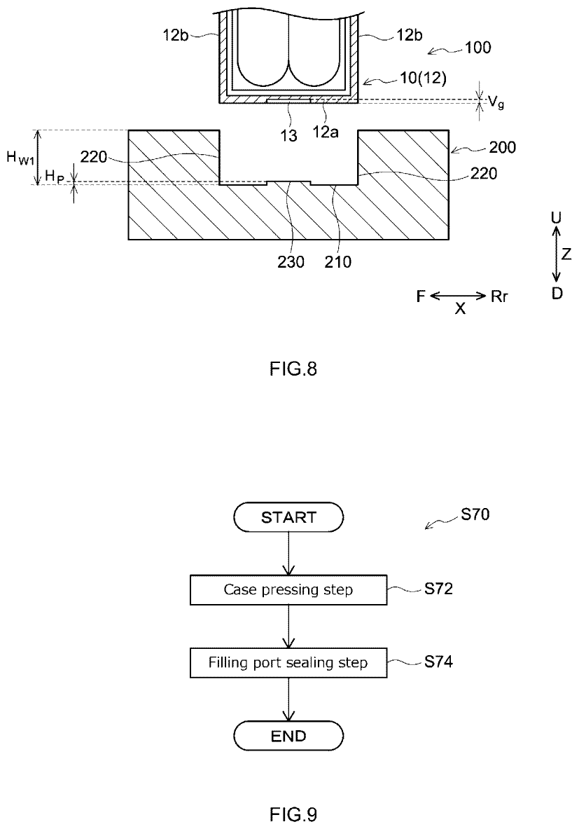

In the case placement step S60, the case 10 is placed on a holding member 200. In this embodiment, the holding member 200 for use in the case placement step S60 is first prepared. FIG. 7 shows a schematic perspective view of the configuration of a holding member 200 according to one embodiment. FIG. 8 shows an enlarged view schematically illustrating the case placement step S60 according to one embodiment. As shown in FIG. 7, the holding member 200 according to this embodiment comprises a base portion 210, a wall portion 220, and a protruding portion 230.

The holding member 200 is preferably made of a metal such as chromium-molybdenum steel. The holding member 200 is composed of a material having higher hardness than a guide portion 320 of a first pressing jig 300 described below. In this embodiment, the holding member 200 is composed of a single member. However, the configuration of the holding member 200 is not limited to this embodiment. For example, a structure may be used in which the wall portion 220 and the protruding portion 230 are joined to the base portion 210. It is noted that the term “hardness” as used in the prevent specification refers to Vickers hardness as measured in accordance with JIS Z2244:2009.

The base portion 210 in this embodiment is a substantially rectangular plate-shaped portion extending along the XY plane. In the case placement step S60, the case 10 is placed on the holding member 200 so that the base portion 210 is brought into contact with the first surface 12a of the case body 12.

There is no particular limitation for the length of the base portion 210 in the long side direction Y, but it is preferably substantially the same as (e.g., ±0.5 mm) or longer than the length of the first surface 12a of the case 10 in the long side direction Y. There is no particular limitation for the length of the base portion 210 in the short side direction X, but it is preferably substantially the same (e.g., ±0.1 mm) or longer than the length of the first surface 12a of the case 10 in the short side direction X. The area of the base portion 210 is preferably equal to or greater than the area of the first surface 12a of the case 10. This can suitably prevent the deformation of the first surface 12a of the case body 12.

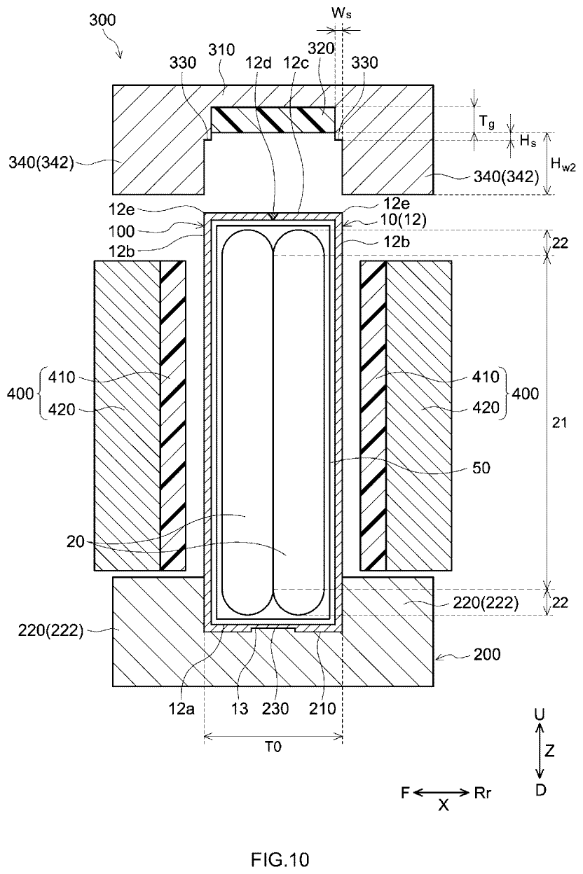

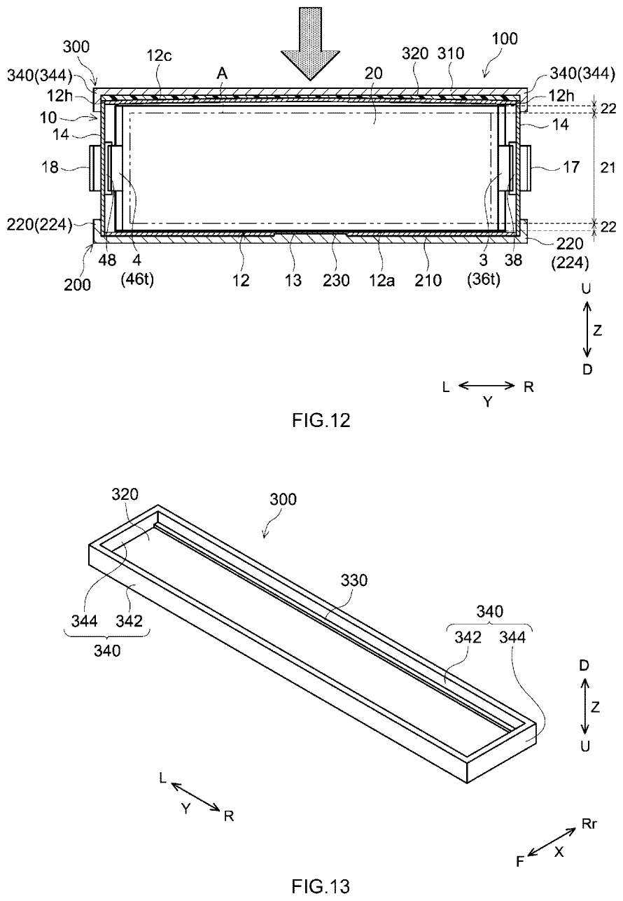

The holding member 200 according to this embodiment further comprises the wall portion 220 extending upward from an end of the base portion 210. The wall portion 220 comprises a pair of first wall portions 222 and a pair of second wall portion 224 in this embodiment. The pair of first wall portions 222 each extend along a direction perpendicular to the base portion 210 (the direction U) from the corresponding end (the long side portion) of the base portion 210 in the short side direction X, and face each other. In this embodiment, the pair of first wall portion 222 is configured such that when the case 10 is placed on the holding member 200, the inner surfaces of the first wall portions 222 abut onto the second surfaces 12b of the case body 12 (see FIG. 10). This enables the movement of the case 10 in the short side direction X to be restricted in the sealing step S70 described below. Therefore, the sealing step S70 can be performed more easily. The pair of second wall portions 224 each extend along a direction perpendicular to the base portion 210 (the direction U) from the corresponding end (the short side portion) of the base portion 210 in the long side direction Y, and face each other. In this embodiment, the pair of second wall portions 224 is configured such that when the case 10 is placed on the holding member 200, the inner surfaces of the second wall portions 224 abut onto the sealing plates 14 (see FIG. 12). This enables the movement of the case 10 in the long side direction Y to be restricted in the sealing step S70 described below. Therefore, the sealing step S70 can be performed more easily. The wall portion 220 may be configured to comprise either one of the pair of first wall portions 222 or the pair of second wall portions 224.

There is no particular limitation for the height H_{w1} of the wall portion 220, but it may be preferably 5 mm or more, and more preferably 10 mm or more in view of suitable restriction of the movement of the case 10 in the short side direction X. There is no particular limitation for the upper limit of the height H_{w1} of the wall portion 220, but it may be preferably 15 mm or less, and more preferably 10 mm or less in view of pressing the second surfaces 12b of the case 10 with the second pressing jigs 400. It is noted that the term “height of the wall portion 220” as used in the present specification refers to the length of a perpendicular line pendent from an end of the wall portion 220 to a surface of base portion 210 which faces the first surface 12a.

The protruding portion 230 is a part which protrudes from the base portion 210 in the direction U. In this embodiment, the protruding portion 230 protrudes in an extending direction of the wall portion 220. As shown in FIGS. 7 and 4, the protruding portion 230 is formed to match the shape of the gas release valve 13 (in this embodiment, a cross shape). As shown in FIG. 8, in the case placement step S60, the case 10 is positioned on the holding member 200 such that the protruding portion 230 fits with the gas release valve 13 of the case body 12. This allows for suitable prevention of the deformation of the gas release valve 13 in addition to the first surface 12a, in the case pressing step S72 described below. This can, in turn, further prevent the deterioration in the operating accuracy of the gas release valve 13.

A height Hₚ of the protruding portion 230 can be appropriately adjusted to match a groove depth V_{g} of the gas release valve 13 (see FIG. 8). Typically, the height Hₚ of the protruding portion 230 of the holding member 200 is equal to or smaller than the groove depth V_{g} of the gas release valve 13 (Hₚ≤V_{g}). The ratio (Hₚ/V_{g}) of the height Hₚ of the protruding portion 230 to the groove depth V_{g} of the gas release valve 13 is preferably 0.1 to 1.0, and more preferably 0.8 to 1.0. This allows for suitable prevention of the deformation of the gas release valve 13 in addition to the first surface 12a, in the case pressing step S72 described below. The shape of the protruding portion 230 can be appropriately altered to match the shape of gas release valve 13.

### (7) Depressurization Step S70

In the sealing step S70, with the third surface 12c of the case 10 pressed in the first surface 12a direction with the first pressing jig 300 at a first load value, and the pair of second surfaces 12b pressed from both sides with the second pressing jigs 400 at a second load value, the filling port 15 is sealed. FIG. 9 shows a flowchart of substeps of the sealing step S70 according to one embodiment. As shown in FIG. 9, the sealing step S70 according to this embodiment includes, as substeps, a case pressing step S72 and a filling port sealing step S74 in this order. It is noted that an aging step may be included either before the sealing step S70 or after the sealing step S70 (before the case pressing step S72 or after the filling port sealing step S74). The aging step may be the same as that used in conventional methods of manufacturing this type of electrical energy storage device, and does not particularly characterize the technology disclosed herein. Therefore, further detailed description will be omitted.

### (7-1) Case Pressing Step S72

In the case pressing step S72, the third surface 12c of the case 10 is pressed with the first pressing jig 300 in the first surface 12a direction (in this embodiment, the direction D) at the first load value. Meanwhile, the pair of second surfaces 12b is pressed with the second pressing jigs 400 from the both sides (in a sandwiching direction) at the second load value. It is noted that in this embodiment, the sealing plates 14 of the case 10 are not pressed with the pressing jigs.

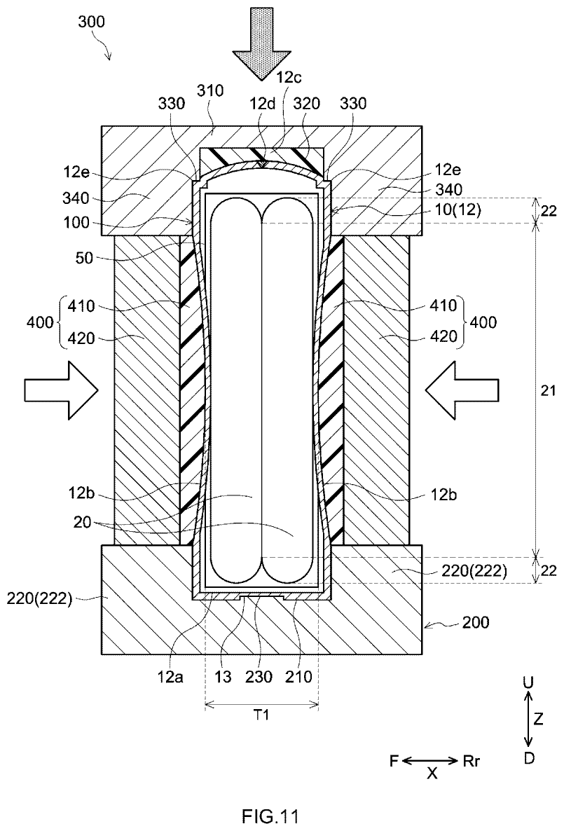

FIGS. 10 to 12 show schematic longitudinal-sectional views during the sealing step (the case pressing step) S70 according to this embodiment. FIG. 10 schematically shows a state before the case body 12 is pressed with the pressing jigs (the first pressing jig 300 and the second pressing jigs 400). FIGS. 11 and 12 schematically show states in which the case body 12 is pressed with the pressingjigs. The electrical energy storage devices 100 shown in FIGS. 10 and 11 corresponds to the electrical energy storage device 100 shown in FIG. 3. The electrical energy storage device 100 shown in FIG. 12 corresponds to the electrical energy storage device 100 shown in FIG. 2. In FIGS. 11 and 12, a pressing direction of the first pressing jig 300 is indicated by a closed arrow, and pressing directions of the second pressing jigs 400 are indicated by open arrows. For illustrative purposes, FIG. 12 shows a region A where one of the second pressing jig 400 is positioned (in other words, a region pressed with one of the second pressing jigs 400), which is indicated by an imaginary line.

In this embodiment, first, the first pressing jig 300 and the pair of second pressing jigs 400 as shown in FIGS. 10 to 12 is prepared as pressing jigs for performing the case pressing step S72.

FIG. 13 shows a perspective view of the first pressing jig 300 according to this embodiment inverted upside down. As shown in FIGS. 10 and 13, the first pressing jig 300 of this embodiment comprises a body portion 310, a guide portion 320, a stepped portion 330, and a wall portion 340. It is noted that the guide portion 320 is one example of the “region of the first pressing jig 300 which faces the third surface 12c of the case body 12” as described in this specification.

In the first pressing jig 300 as disclosed herein, a region (the guide portion 320) facing the third surface 12c of the case body 12 is composed of a material with relatively lower hardness than that of the holding member 200. As will be described in detail below, this can facilitate outward deformation (in the direction U) of the third surface 12c of the case body 12 during the case pressing step S72. The guide portion 320 is preferably composed of a material which will undergo deformation when stress is applied. Such a material is preferably made of a resin, and more preferably consists of polyurethane, acrylic urethane, or the like.

There is no particular limitation for the material of the portions (the body portion 310, the stepped portion 330, and the wall portion 340) of the first pressing jig 300 other than the region facing the third surface 12c of the case body 12, but it may be the same as or different from that of the guide portion 320. Further, the portions of the first pressing jig 300 other than the region facing the third surface 12c of the case body 12 are preferably composed of a material having higher hardness than the guide portion 320. This enables the first pressing jig 300 to be easily pressed in the first surface 12a direction of the case body 12. Such a material is preferably made of a metal such as chromium-molybdenum steel. It is noted that the guide portion 320 is one example of a “first member” as described in the present specification. It is noted that the body portion 310, the stepped portion 330, and the wall portion 340 are examples of a “second member relatively harder than the first member” as described in the present specification. As shown in FIG. 10, in this embodiment, the guide portion 320 (the first member) of the first pressing jig 300 is made of a resin (polyurethane), while portions except for the guide portion 320 (the second member) is made of a metal.

The body portion 310 is a substantially rectangular flat portion extending along the XY plane. The guide portion 320 is formed on one surface of the body portion 310. Although not shown in the figure, a driving device for driving the first pressing jig 300, such as a cylinder, may be connected to the other surface of the body portion 310.

As shown in FIGS. 10, 12, and 13, the guide portion 320 is a substantially rectangular flat portion extending along the XY plane. There is no particular limitation for the length of the guide portion 320 in the long side direction Y, but it is preferably substantially the same as or greater than the length of the third surface 12c of the case 10 in the long side direction Y. There is no particular limitation for the area of the guide portion 320, but it is preferably 80% or more, and more preferably 95% or more when the area of the third surface 12c of the case 10 is set to 100%. Further, the area of the guide portion 320 is preferably 100% or less, and more preferably 98% or less when the area of the third surface 12c of the case 10 is set to 100%. This can suitably facilitate outward (in the direction U) deformation (expansion) of the third surface 12c of the case body 12 during the case pressing step S72.

There is no particular limitation for a thickness T_{g} (the thickness in the vertical direction Z) of the guide portion 320 (see FIG. 10), but it is preferably 10 mm or more, and more preferably 15 mm or more. This can suitably facilitate outward (in the direction U) deformation (expansion) of the third surface 12c of the case body 12 during the case pressing step S72. Meanwhile, there is no particular limitation for the upper limit of the thickness T_{g} (the thickness in the vertical direction Z) of the guide portion 320, but it may be, for example, 50 mm or less.

As shown in FIGS. 10 and 13, the first pressing jig 300 according to this embodiment further comprises the stepped portion 330 protruding toward the case body 12 (the direction D) from each end of the guide portion 320 in the short side direction X. As shown in FIG. 13, the stepped portion 330 in this embodiment is provided between the guide portion 320 and a first wall portion 342. As shown in FIG. 13, the stepped portion 330 extends along the long side direction Y. To elaborate, the stepped portion 330 is configured to press a pair of edge portions 12e (and the vicinity of the edge portions 12e) where the third surface 12c of the case body 12 intersects with the pair of the second surfaces 12b. As shown in FIG. 10, the stepped portion 330 according to this embodiment protrudes toward the direction of the case body 12 (the direction D) from the guide portion 320. This configuration ensures that the stepped portion 330 is brought into contact with the edge portion 12e before the guide portion 320 does. According to this configuration, the case 10 can be pressed more reliably in the direction of the first surface 12a in the case pressing step S72. Therefore, this can prevent the case 10 from floating in the height direction Z.

There is no particular limitation for a width Wₛ of the stepped portion 330 in the short side direction X (see FIG. 10), but it is preferably 1.0 mm or more, and more preferably 5.0 mm or more in view of ensuring reliable contact between the edge portion 12e and the stepped portion 330. There is no particular limitation for a height Hs of the stepped portion 330 (see FIG. 10), but it is preferably 10 mm or more, and more preferably 20 mm or more in view of promoting the outward (in the direction U) deformation (expansion) of the third surface 12c of the case 10. On the other hand, in view of ensuring more reliable contact between the edge portion 12e of the case 10 and the stepped portion 330, the height Hs of the stepped portion 330 is preferably, but not limited to, 50 mm or less, and more preferably 30 mm or less.

The first pressing jig 300 according to this embodiment further comprises the wall portion 340 extending upward from an end of the body portion 310. As shown in FIGS. 10 and 12, the wall portion 340 in this embodiment comprises a pair of first wall portions 342 and a pair of second wall portions 344. The pair of first wall portions 342 each extend in a direction perpendicular to the body portion 310 (the direction D) from the corresponding end (the long side portion) of the body portion 310 in the short side direction X, and face each other. As shown in FIG. 10, the pair of first wall portions 342 protrudes further than the stepped portion 330. In this embodiment, the pair of first wall portions 342 is configured such that when the case 10 is pressed with the first pressing jig 300, the inner surfaces of the first wall portions 342 abut onto the second surfaces 12b of the case body 12. This allows the sealing step S70 to be performed while the first pressing jig 300 is secured in the short side direction X. This enables more reliable pressing of the case body 12 with the first pressing jig 300. The pair of second wall portions 344 each extend in a direction perpendicular to the body portion 310 (the direction U) from the corresponding end (the short side portion) of the body portion 310 in the long side direction Y, and face each other. In this embodiment, the pair of second wall portions 344 is configured such that when the case 10 is pressed with the first pressing jig 300, the inner surfaces of the second wall portions 344 abut onto the sealing plates 14. This allows the sealing step S70 to be performed while the first pressing jig 300 is secured in the long side direction Y. This enables more reliable pressing of the case body 12 with the first pressing jig 300. The wall portion 340 may be configured to comprise either one of the pair of first wall portions 342 or the pair of second wall portions 344.

There is no particular limitation for a height H_{w2} of the wall portion 340, but it is preferably 50 mm or more, and more preferably 100 mm or more in view of suitable restriction of the movement of the case 10 in the short side direction X. There is no particular limitation for the upper limit of the height H_{w2} of the wall portion 340, but it is preferably 500 mm or less, and more preferably 300 mm or less in view of pressing the second surfaces 12b of the case 10 with the second pressing jigs 400. It is noted that the term “height of the wall portion 340” as used in the present specification refers to the length of a perpendicular line pendent from an end of the wall portion 340 to a surface of the guide portion 320 which faces the third surface 12c.

As shown in FIG. 10, the second pressing jigs 400 according to this embodiment each comprises a pressing portion 410 and a body portion 420. The pressing portion 410 is a portion which contacts one of the pair of second surfaces 12b of the case body 12. The pressing portion 410 is formed in a flat manner along one of the pair of second surfaces 12b of the case body 12 (in the YZ plane). The body portion 420 is a flat plate-shaped portion extending in the YZ plane. In this embodiment, the pressing portion 410 is formed on one of the surfaces of the body portion 420. However, the pressing portion 410 may be a convexly curved surface (R shaped) curved toward the second surface 12b. Although not shown in the figure, a driving device for driving the second pressing jigs 400, such as a clamp, may be connected to the other surface of the body portion 420.

There is no particular limitation for the material of the second pressing jigs 400. When the second pressing jigs 400 each comprise a pressing portion 410 and a body portion 420, the body portion 420 is preferably composed of a material having a relatively higher hardness than that of the pressing portion 410. This enables the body portion 420 to exert a sufficient load value on the second surface 12b of the case body 12 while allowing the pressing portion 410 to protect the surface of the second surface 12b of the case body 12. The pressing portion 410 is preferably made of a resin, and the body portion 420 is preferably made of a metal. Examples of a material which can be used for the pressing portion 410 include polypropylene, and the like. Examples of a material which can be used for the body portion 420 include duralumin, and the like. The pressing portion 410 may be composed of a material which will undergo deformation under a pressing force of the case 10.

As shown in FIG. 10, in the case pressing step S72, the first pressing jig 300 is positioned to cover the third surfaces 12c. In this embodiment, the first pressing jig 300 is positioned such that the third surface 12c and the guide portion 320, and the edge portion 12e and the stepped portion 330 face each other, respectively. Meanwhile, the pair of second pressing jigs 400 is positioned so as to sandwich the case body 12 via the pair of second surfaces 12b from the both sides. In this embodiment, the pair of second pressing jigs 400 is positioned such that the second surfaces 12b and the pressing portions 410 face each other.

Then, as shown in FIG. 11, the pair of second surfaces 12b of the case body 12 is pressed with the second pressing jigs 400 at the second load value from the both sides inward direction of the case body 12 (in other words, in the sandwiching direction of the second pressing jigs 400, or in the electrode body 20 direction) (the directions of the open arrows). In other words, portions of the second surfaces 12b which abut onto the second pressing jigs 400 (the pressing portions 410) are pressed toward the inside of the case body 12 (toward the electrode body 20). Consequently, as shown in FIG. 11, the second surfaces 12b are deformed toward the inner surfaces of the case body 12 (toward the electrode body 20) (in other words, deformed concavely).

Here, in manufacture of a typical electrical energy storage device 100, the case body 12 undergo deformation so as to expand in the height direction Z, as well as deformation of the pair of second surfaces 12b as described above. In other words, the first surface 12a of the case body 12 is curved outward (in the direction D), and the third surface 12c is curved outward (in the direction U). When the case 10 comprises the gas release valve 13 on the first surface 12a, the first surface 12a may undergo deformation, potentially causing the gas release valve 13 to operate inaccurately.

In contrast, in the manufacturing method according to the present disclosure, the third surface 12c of the case body 12 is pressed with the first pressing jig 300 in the direction of the first surface 12a (the direction Z in FIG. 11) (the direction of the closed arrow) at the first load value in addition to the pressing of the second surfaces 12b as described above. This can prevent the case 10 from floating upward in the vertical direction Z. At this time, a force pressing the first surface 12a against the holding member 200 is further applied. This can prevent the first surface 12a from deforming (expanding) outward (in the direction D). Meanwhile, the guide portion 320 of the first pressing jig 300 is composed of a material having relatively lower hardness than the holding member 200. Because of this, the outward (in the direction U) deformation (expansion) of the third surface 12c of the case body 12 is not prevented by the guide portion 320. Therefore, a force causing the case body 12 to deform so as to expand in the height direction Z acts on the third surface 12c, causing the third surface 12c to deform outward (in the direction U). According to this method, the pair of second surfaces 12b of the case body 12 is allowed to be deformed while preventing the deformation of the first surface 12a (see FIGS. 11 and 12).

The magnitude of the first load (the pressing force) may be appropriately altered depending on the size of the case 10 and the material of the case 10. The magnitude of the first load (the pressing force) is preferably, but not limited to, 1 kN or more, more preferably 2 kN or more, and most preferably 3 kN or more. On the other hand, the magnitude of the first load (the pressing force) is preferably be 6 kN or less, more preferably 5 kN or less, and most preferably 4 kN or less.

In the manufacturing method disclosed herein, the magnitude of the second load is larger than that of the first load. This can prevent the first surface 12a of the case 10 from floating in the vertical direction Z while reducing the expansion of the case 10. The magnitude of the second load (the pressing force) may be appropriately altered depending on the size of the case 10 and the material of the case 10. The magnitude of the second load (the pressing force) is preferably, but not limited to, 1 kN or more, more preferably 5 kN or more, and most preferably 10 kN or more. On the other hand, the magnitude of the second load (the pressing force) is preferably be 40 kN or less, more preferably 30 kN or less, and most preferably 20 kN or less.

At the pair of second surfaces 12b of the case body 12, the pressing amount of the second pressing jigs 400 is preferably about 0.5 to 5 mm, and more preferably about 0.5 to 2 mm. This suitably prevent the case 10 from expanding convexly during charging and discharging of the electrical energy storage device 100. It is noted that the term “pressing amount” as used in this specification refers to the difference (i.e., T0−T1) in the short side direction X between the thickness (distance) T0 of the case 10 before the case pressing step S72 (see FIG. 10) and the thickness T1 of the case 10 at the case pressing step S72 (see FIG. 11). The thickness T1 refers to the thickness (distance) of a region having the smallest thickness in the case 10 (in other words, a region where the second surfaces 12b are most deeply pressed) at the case pressing step S72. In planar view, a region A where the case 10 is pressed with the second pressing jigs 400 preferably includes a region of the flat portion 22 of the electrode body 20 which includes the positive electrode active material layer 31.

When the case body 12 includes the welded joint 12d, the welded joint 12d is preferably provided on the third surface 12c. Then the case pressing step S72 is preferably performed while the welded joint 12d and the guide portion 320 of the first pressing jig 300 are positioned so as to face each other. According to this configuration, the case pressing step S72 can be performed while the welded joint 12d is protected by the guide portion 320.

### (7-2) Filling Port Sealing Step S74

In the filling port sealing step S74, the filling port 15 of the case 10 is sealed while the case body 12 is in a pressed state (in other words, a state where the second surfaces 12b of the case body 12 are deformed toward the inner surfaces of the case body 12) in the case pressing step S72. By this, the filling port 15 is sealed while the internal volume of the case 10 is reduced. Therefore, the expansion of the case 10 in the thickness direction (the short side direction X) due to gas generation during charging and discharging of the electrical energy storage device 100. In this embodiment, the filling port 15 is sealed by a sealing member 16 made of a metal, and the filling port 15 is further sealed by welding a metal portion of the sealing member 16 to the case 10. However, a method of sealing the filling port 15 is not limited to this. Although not shown in the figures, the filling port 15 may be sealed with, for example, a rivet such as a blind rivet.

As described above, the method of manufacturing the electrical energy storage device 100 disclosed herein can prevent deterioration in the operating accuracy of the gas release valve caused by case pressing when the case 10 is pressed. Further, the electrical energy storage device 100 manufactured by this method can prevent the expansion of the case 10 due to gas generation during charging and discharging.

The electrical energy storage device 100 can be used for various applications, and typically well-suited for use as a power source (electrical driving power source) for motors installed in various vehicles, for example, passenger cars, trucks, and the like. There is no particular limitation for the types of vehicles, but they include, for examples, plug-in hybrid electric vehicles (PHEVs), hybrid electric vehicles (HEVs), battery electric vehicles (BEVs), and the like. Further, the electrical energy storage device 100 can be suitably used for constructing electrical energy storage modules.

In the above, several embodiments of the technology disclosed herein are described, but these embodiments are merely examples. The technology disclosed herein may be implemented in other various forms. The technology disclosed herein can be implemented based on the contents disclosed in the present specification and the common technical knowledge in the art. The technology described in the claims encompasses various modifications and alterations of the specific examples illustrated in the foregoing descriptions. For example, the aforementioned embodiments may be partly replaced with other variations, and the aforementioned embodiments may be added to other variations. Further, technical features, which are not described as essential, may be omitted as appropriate.

As described above, the specific aspects of the technology disclosed herein include those described in the following items.

### <Item 1>

A method of manufacturing an electrical energy storage device,
the electrical energy storage device comprising:
   an electrode body including a positive electrode and a negative electrode, an electrolyte solution, and a case for housing the electrode body and the electrolyte solution, wherein
   the case comprises a case body having a first surface of a rectangular shape having a pair of long sides and a pair of short sides, a pair of second surfaces each extending from a corresponding long side of the pair of long sides and having a larger area than the first surface, a third surface opposite to the first surface, and one or more openings, and
   one or more sealing plates for sealing the one or more openings, wherein
   the first surface comprises a gas release valve, and
the method comprising:
   a liquid-filling step of filling the electrolyte solution into the case through the filling port provided in the case,
   a charging step of performing charging,
   a case placement step of placing the case on a holding member, and
   a sealing step of sealing the filling port while the third surface is pressed in the first surface direction with a first pressing jig at a first load value, and the pair of second surfaces is pressed with second pressing jigs at a second load value to deform the second surfaces toward inner surfaces of the case body, wherein
   in the case placement step,
   the holding member comprises a base portion, and
   the case is placed on the holding member so that the base portion is brought into contact with the first surface of the case body, and
   in the sealing step,
   a region of the first pressing jig where the first pressing jig faces the third surface of the case body is composed of a material having relatively lower hardness than the holding member, and
   the second load value is larger than the first load value.

### <Item 2>

The method of manufacturing an electrical energy storage device according to Item 1, wherein
the first pressing jig comprises a first member and a second member having a relatively higher hardness than the first member, and
the sealing step is performed while the first member of the first pressing jig is brought into contact with the third surface of the case body.

### <Item 3>

The method of manufacturing an electrical energy storage device according to Item 1 or 2, wherein
the first pressing jig comprises stepped portions, and
the third surface is pressed with the first pressing jig so that a pair of edge portions where the third surface of the case body intersects with the pair of the second surfaces is pressed with the stepped portions.
   <item 4>

The method of manufacturing an electrical energy storage device according to any one of Items 1 to 3, wherein
the holding member further comprises a protruding portion, and
the case placement step is performed so that the protruding portion fits with the gas release valve of the case body.
   <item 5>

The method of manufacturing an electrical energy storage device according to any one of Items 1 to 4, wherein
the second pressing jigs comprise pressing portions and body portions having a relatively higher hardness than the pressing portions, and
the sealing step is performed while the pressing portions of the second pressing jigs are brought into contact with the second surfaces.

### <Item 6>

The method of manufacturing an electrical energy storage device according to any one of Items 1 to 5, wherein
the holding member further comprises a pair of wall portions extending upward from the base portion, and
the case placement step is performed so that the pair of wall portions of the holding member and the pair of second surfaces of the case body are brought into contact with each other.
   <item 7>

The method of manufacturing an electrical energy storage device according to any one of Items 1 to 6, wherein
the plate thickness of the one or more sealing plates is larger than the plate thickness of the case body.

What is claimed is:

1. A method of manufacturing an electrical energy storage device,
the electrical energy storage device comprising:
an electrode body including a positive electrode and a negative electrode, an electrolyte solution, and a case for housing the electrode body and the electrolyte solution, wherein
the case comprises a case body having a first surface of a rectangular shape having a pair of long sides and a pair of short sides, a pair of second surfaces each extending from a corresponding long side of the pair of long sides and having a larger area than the first surface, a third surface opposite to the first surface, and one or more openings, and
one or more sealing plates for sealing the one or more openings, wherein
the first surface comprises a gas release valve, and
the method comprising:
a liquid-filling step of filling the electrolyte solution into the case through the filling port provided in the case,
a charging step of performing charging,
a case placement step of placing the case on a holding member, and
a sealing step of sealing the filling port while the third surface is pressed in the first surface direction with a first pressing jig at a first load value, and the pair of second surfaces is pressed with second pressing jigs at a second load value to deform the second surfaces toward inner surfaces of the case body, wherein
in the case placement step,
the holding member comprises a base portion,
the case is placed on the holding member so that the base portion is brought into contact with the first surface of the case body, and
in the sealing step,
a region of the first pressing jig where the first pressing jig faces the third surface of the case body is composed of a material having relatively lower hardness than the holding member, and
the second load value is larger than the first load value.

2. The method of manufacturing an electrical energy storage device according to claim 1, wherein
the first pressing jig comprises a first member and a second member having a relatively higher hardness than the first member, and
the sealing step is performed while the first member of the first pressing jig is brought into contact with the third surface of the case body.

3. The method of manufacturing an electrical energy storage device according to claim 1, wherein
the first pressing jig comprises stepped portions, and
the third surface is pressed with the first pressing jig so that a pair of edge portions where the third surface of the case body intersects with the pair of the second surfaces are pressed with the stepped portions.

4. The method of manufacturing an electrical energy storage device according to claim 1, wherein
the holding member further comprises a protruding portion, and
the case placement step is performed so that the protruding portion fits with the gas release valve of the case body.

5. The method of manufacturing an electrical energy storage device according to claim 1, wherein
the second pressing jigs comprise pressing portions and body portions having a relatively higher hardness than the pressing portions, and
the sealing step is performed while the pressing portions of the second pressing jigs are brought into contact with the second surfaces.

6. The method of manufacturing an electrical energy storage device according to claim 1, wherein
the holding member further comprises a pair of wall portions extending upward from the base portion, and
the case placement step is performed so that the pair of wall portions of the holding member and the pair of second surfaces of the case body are brought into contact with each other.

7. The method of manufacturing an electrical energy storage device according to claim 1, wherein
the plate thickness of the one or more sealing plates is larger than the plate thickness of the case body.
